(19) United States
(12) Patent Application Publication
(10) Pub. No.: US 2012/0005042 A1
(43) Pub. Date: Jan. 5, 2012

(54) PRODUCTS AND SERVICES PROMOTION SYSTEM AND METHOD

(76) Inventor: David C.A. Pigott, Miami, FL (US)

(21) Appl. No.: 13/173,993

(22) Filed: Jun. 30, 2011

Related U.S. Application Data
(60) Provisional application No. 61/360,348, filed on Jun. 30, 2010.

(51) Int. Cl. G06Q 30/00

(52) U.S. Cl. 705/27.1

(57) ABSTRACT

A method on a server for facilitating sales over a communications network is disclosed. The method includes providing a graphical user interface to an online marketplace of goods, receiving, via the graphical user interface, a selection of goods and a salesman identifier from a consumer and receiving, via the graphical user interface, sales transaction data comprising purchase of the selection of goods by the consumer. The method further includes processing the sales transaction data to effectuate purchase of the selection of goods by the consumer, matching the salesman identifier to a stored record that corresponds to the salesman and transferring a credit to the salesman based on the sales transaction data.

### CROSS-REFERENCE TO RELATED APPLICATIONS

This application claims priority to provisional patent application No. 61/360,348 filed Jun. 30, 2010. The subject matter of provisional patent application No. 61/360,348 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field of sales, advertising and marketing and, more specifically, the present invention relates to the field of online systems that facilitate sales.

### BACKGROUND OF THE INVENTION

The value of using salespeople at stand-alone brick and mortar stores, storefronts, kiosks and door-to-door has been known for centuries. Consumers respond positively to salespeople with whom a relationship is established, developing a sense of trust with the salesperson and heeding the salesperson's advice. This process is known to increase sales and produce repeat customers.

The advent of the Internet, however, has provided the consuming public another means to purchase goods and services. One advantage of the Internet is the consumer's ability to purchase products from his or her residence or office, without having to visit a physical store. The Internet also provides a means to purchase goods and services anonymously. There have been numerous systems and prior methods implemented to promote the sale of goods and services via networked computer systems such as the Internet. None of these systems, however, provide an overall system or platform that facilitates the sale of products and services between a consumer through a sales person or through a person having a prior relationship with that consumer. Removed from the transaction was the human element, the trusted salesperson that could provide guidance and insight into the desired goods or services.

Moreover, even systems that allow a consumer to contact a sales representative fail to provide a mechanism that allows consumers to go back to the same salesperson or to recommend that salesperson to another. Finally, from the perspective of the provider of the products and services, none of the prior systems provide for a recruiting tool to attract qualified salespersons to handle consumer product promotions and queries.

Therefore, what is needed is a system and method for improving the problems with the prior art, and more particularly for a more efficient method and system for facilitating sales activities and rewarding those who promote sales.

### SUMMARY OF THE INVENTION

In one embodiment, the present invention discloses a method on a server for facilitating sales over a communications network. The method includes providing a graphical user interface to an online marketplace of goods, receiving, via the graphical user interface, a selection of goods and a salesman identifier from a consumer and receiving, via the graphical user interface, sales transaction data comprising purchase of the selection of goods by the consumer. The method further includes processing the sales transaction data to effectuate purchase of the selection of goods by the consumer, matching the salesman identifier to a stored record that corresponds to the salesman and transferring a credit to the salesman based on the sales transaction data.

In another embodiment, the present invention discloses a method on a server for facilitating sales over a communications network. The method includes providing a graphical user interface to an online marketplace of goods, receiving, via the graphical user interface, a selection of goods and a referral identifier from a first consumer and receiving, via the graphical user interface, sales transaction data comprising purchase of the selection of goods by the first consumer. The method further includes processing the sales transaction data to effectuate purchase of the selection of goods by the first consumer, and matching the referral identifier to a stored record that corresponds to the salesman and a stored record corresponding to a second consumer. The method further includes transferring a credit to the salesman based on the sales transaction data and transferring a credit to the second consumer based on the sales transaction data.

In another embodiment, the present invention discloses a system for facilitating sales over a communications network. The system includes a database for storing records corresponding to salesmen and consumers. The system further includes a central server configured for providing a graphical user interface to an online marketplace of goods, receiving, via the graphical user interface, a selection of goods and a salesman identifier from a consumer, receiving, via the graphical user interface, sales transaction data comprising purchase of the selection of goods by the consumer, processing the sales transaction data to effectuate purchase of the selection of goods by the consumer, matching the salesman identifier to a record in the database that corresponds to the salesman and transferring a credit to the salesman based on the sales transaction data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for facilitating sales activities and transfer of sales commissions over a communications network, in accordance with one embodiment of the present invention.

FIG. 2 is a block diagram showing the various record types that may be stored in a database according to one embodiment of the present invention.

FIG. 3 is a flow chart showing the control flow of the sales and commission process according to one embodiment of the present invention.

### DETAILED DESCRIPTION OF THE INVENTION

The present invention improves upon the problems with the prior art by providing a more efficient method and system for facilitating sales activities and crediting sales commissions on networked computing devices, both mobile and non-mobile. The present invention facilitates the personal work of salespeople in promoting sales to consumers, while leveraging the use of online electronic commerce to effectuate sales and deliver purchased goods. The present invention also provides a mechanism for allowing consumers to return to the same salespeople with whom the consumer has a relationship and allows the consumers to refer other consumers the same salesperson. Additionally, the present invention provides a recruiting tool to attract qualified salespersons to handle consumer product promotions and queries over a networked system. Lastly, the present invention provides a system for compensating salespeople and referring consumers with sales commissions for promoting the sale of goods.

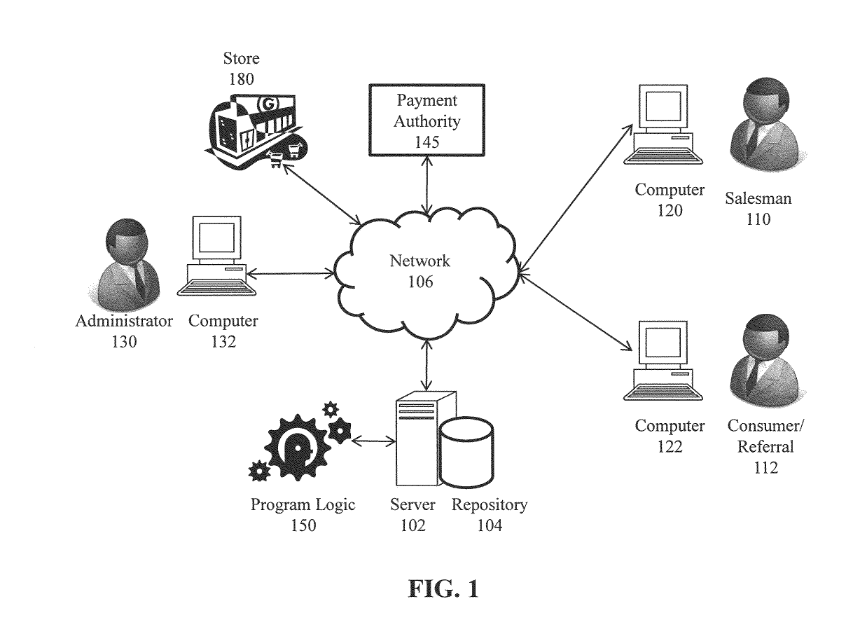

Referring now to the drawing figures in which like reference designators refer to like elements, there is shown in FIG. 1 an illustration of a block diagram showing the network architecture of a system and method for facilitating sales and transfer of sales commissions over a communications network in accordance with the principles of the present invention. The most prominent element of FIG. 1 is the server 102 associated with repository or database 104 and further coupled with network 106, which can be a circuit switched network, such as the Public Service Telephone Network or a packet switched network such as the Internet or the World Wide Web.

Server 102 is a central controller or operator for the functionality that executes on computers 120, 122 and 132, namely, the processing of sales transactions, as well as the processing of credits provided to the users 110, 112 as sales commissions, wherein the provision of the foregoing services and data facilitates the performance of sales activities. Server 102 provides an online marketplace wherein consumers may purchase goods or services promoted by salesmen, wherein salesmen receive commissions for sales attributed to them. Server 102 may work in conjunction with brick and mortar retail store 180.

FIG. 1 further includes computers 120 and 122, which may be desktops, work stations, laptops, smart phones, mobile phones, tablet computers, handheld computers, laptops, or the like. Computers 120 and 122 correspond to a salesman 110 and consumer 112 of the salesman 110. A salesman 110, also known as a promoter, is a member of a sales force who sells products to customers or consumers. A salesman 110 receives compensation for his own product sales, often via a commission. A customer or consumer simply refers to a person to whom a salesmen sales products or services. A consumer 112 may also be called a “referral” if another consumer has referred the person 112 to use the services of the salesman 110. In those cases, the referring consumer may receive compensation for sales attributed to the referral, often via a commission.

Computer 132 corresponds to an administrator 130, who may perform supervisory or administrative tasks on server 102. Administrator 130 may, for example, initiate promotions, discounts, sales, or set sales milestones for the users 110, 112. Computer 132 may be a mobile computer, a desktop computer, a common computer terminal or the like.

FIG. 1 further shows that server 102 includes a database or repository 104, which may be a relational database comprising a Structured Query Language (SQL) database stored in a SQL server. Client computers 120, 122 and 132 may also each include their own database. The repository 104 serves data from a database, which is a repository for data used by server 102 and the client computers during the course of operation of the invention.

FIG. 1 shows an embodiment of the present invention wherein networked computing devices 120, 122 and 132 interact with server 102 and repository 104 over the network 106. Server 102 includes a software engine that delivers applications, data, program code and other information to networked computing devices 120, 122 and 132. The software engine of server 102 may perform other processes such as audio and/or video streaming or other standards for transferring multimedia data in a stream of packets that are interpreted and rendered by a software application as the packets arrive. It should be noted that although FIG. 1 shows only three networked computing devices 120, 122 and 132, the system of the present invention supports any number of networked computing devices connected via network 106.

In one embodiment of the present invention, the application provided by the server 102 of FIG. 1 is a client-server application having a client portion that resides on a client computer (i.e., 120, 122 and 132) and a server application that resides on server 102. For example, the application can be a web interface that is accessed by a client computer via network 106. The application served by server 102 may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

Server 102 includes program logic 150 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 150 may reside on a client computer, the server 102 or any combination of the two.

Note that although server 102 is shown as a single and independent entity, in one embodiment of the present invention, the functions of server 102 may be integrated with another entity, such as one of the client computers 120, 122, 132 or payment authority 145. Further, server 102 and its functionality, according to a preferred embodiment of the present invention, can be realized in a centralized fashion in one computer system, or in a distributed fashion where different elements are spread across several interconnected computer systems.

The network architecture of FIG. 1 in accordance with the principles of the present invention may give rise to various revenue-generating arrangements. The users 110, 112 may, for example, purchase of sale products via the application of the present invention and refer other consumers to do the same. The users 110, 112 may also, for example, pay an ongoing or per-transaction fee to the operators of server 102 in exchange for the services provided by server 102.

FIG. 1 also shows a payment authority 145 to effectuate payments by a consumer 112 for products, services or the like. In the course of a sales transaction, the program logic 150 may interface with payment authority 145 to effectuate payment. In one embodiment of the present invention, the payment authority 145 is a payment gateway, which is an e-commerce Application Service Provider (ASP) service that authorizes payments for individuals, e-businesses, online retailers, or traditional brick and mortar businesses. The payment authority 145 may accept payment via the use of credit cards, charge cards, bank cards, gift cards, account cards, etc.

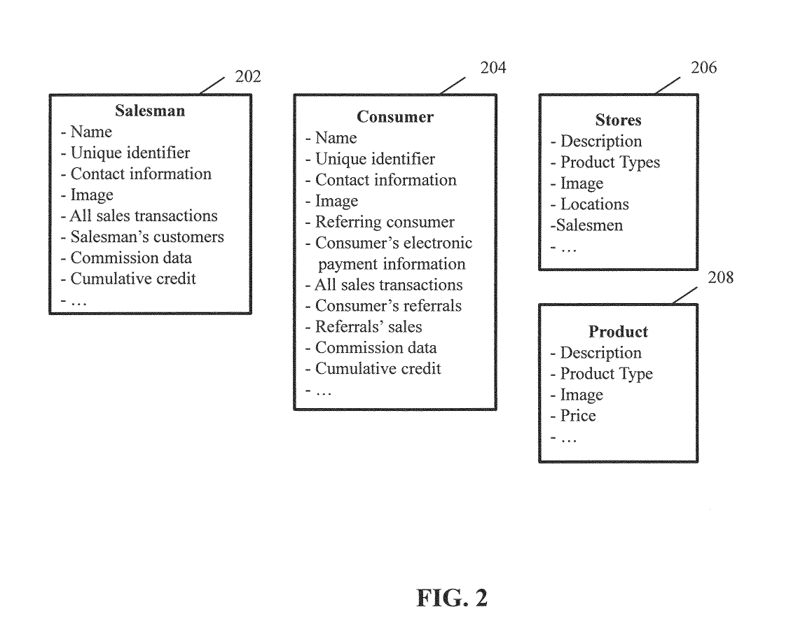

FIG. 2 is a block diagram showing the various record types that may be stored in the database 104 according to one embodiment of the present invention. The database 104 may include a record 202 for each salesman 110. The record may include: contact/identifying information for the salesman, a unique identifier for the salesman, a photo of the salesman, information pertaining to consumer purchases attributed to the salesman, contact/identifying information for customers of the salesman, electronic payment information for the consumers, information pertaining to commission calculations for the salesman, cumulative credit attributed to commissions, etc.

The database 104 may also include a record 204 for each consumer 112. The record may include: contact/identifying information for the consumer, a unique identifier for the consumer, a photo of the consumer, contact/identifying information for the person that referred the consumer (if any), information pertaining to purchases attributed to the consumer, contact/identifying information for referrals of the consumer, information pertaining to purchases attributed to referrals of the consumer, electronic payment information for the consumer, information pertaining to commission calculations for the consumer, cumulative credit attributed to commissions, etc.

Sales transaction data, as shown above, may be stored in the database 104 and associated with a record for the salesman initiating the sale, the consumer that referred the purchaser to the salesman (if any), and/or the consumer making the purchase. Sales transaction data may include one or more product identifiers, one or more product amounts, buyer contact/identifying information, product shipping information and electronic payment information. In one embodiment, electronic payment information may comprise buyer contact/identifying information, credit card data garnered from a credit or debit card and authentication information.

The database 104 may also include a record 206 for each brick and mortar retail store 180. The record may include: a description of the store, an image of the store, a list of product types carried by the store, a list of geographical locations of the store, a list of salesmen associated with the store or who sell/promote the store's products, etc. The database 104 may also include a record 208 for product or service 208. The record may include: a description of the product, a product type, an image of the product, a product price, a list of geographical locations of the stores carrying the products, a list of salesmen associated whom sell/promote the products, etc. Note that any of the records 202-208 may include links to other records. For example, salesman record 202 may include links to consumer records 204 and store record 206 may include links to product records 208.

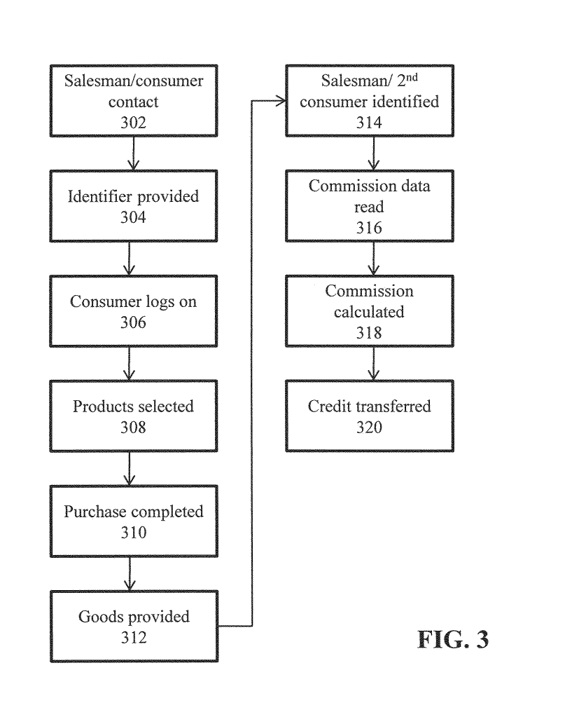

FIG. 3 is a flow chart showing the control flow of the sales and commission process according to one embodiment of the present invention. FIG. 3 illustrates the process by which a first customer makes a purchase using the system of the present invention, thereby resulting in the issuance of a commission to a salesman and/or a referring consumer. In step 302, a first consumer 112 comes into contact with a salesman 110 or a second consumer who promotes the purchase of one or more products from store 180. In step 304, the consumer 112 responds to the promotion and decides to purchase the one or more products online. The salesman 110 or second consumer provides the consumer 112 an identifier, such as a text string, or a URL for the purchase of the goods online. The identifier is associated with the salesman 110. If the identifier was provided by the second consumer, the identifier is also associated with the second consumer.

In step 306, the consumer 112 logs onto the online marketplace of server 102, associated with store 180, and enters the identifier, which is associated with the subsequent purchase, into a graphical user interface. The identifier may produce a predefined web page or interface for the consumer 112. Optionally, the consumer 112 enters identifying information about the consumer 112, which may be stored in a consumer record 204 in database 104. The consumer 112 is provided with a graphical user interface that allows the consumer to provide search queries to search for salesmen by any of the data in record 202, to search for other consumers by any of the data in record 204, to search for any store by any of the data in record 206 and to search for products by any of the data in record 208. The graphical user interface may provide the consumer with various different types of views, which may be customizable, for viewing stores, products, salespeople and other consumers.

Next, in step 308, the consumer selects, via the graphical user interface, the one or more products for purchase, which product information may be stored in a consumer record 204 in database 104. In step 310, the consumer 112 enters electronic payment information into the graphical user interface for the purchase of the one or more goods, which payment information may be stored in a consumer record 204 in database 104. The program logic 150 of server 102 sends the electronic payment information to the payment authority 145 for confirmation of payment. Once confirmation of payment is received, in step 312 the purchase of the goods is complete and the goods are either shipped to the consumer 112 or the consumer 112 is provided with a time and place at store 180 at which to pick up the purchased goods.

In step 314, the sales program logic 150 of server 102 determines which salesman 110 and second consumer, if any, corresponds to the identifier entered by the consumer 112 in step 306. The logic 150 may, for example, search a predefined list or hash table to determine which salesman 110 and second consumer, if any, corresponds to the identifier. The logic 150 may alternatively search the salesman records 202 and consumer records 204 and compare the provided identifier to the identifiers in the records 202, 204, thereby looking for a match. Once the logic 150 determines which salesman 110 and second consumer, if any, corresponds to the identifier, the logic 150 accesses the record for the salesman 110 and second consumer, if any, corresponding to the identifier. In step 316, the logic 150 reads the commission data in the records 202, 204 salesman 110 and second consumer to determine how to calculate the commission for the salesman 110 and second consumer, if any. Commission data may be, for example, a percentage of the gross sale price of any goods purchased by a customer.

In step 318, based on the commission data, the logic 150 of the server 102 calculates the commission for the salesman 110 and second consumer, if any. In step 320, the commission calculated for the salesman 110 and second consumer, if any, is transferred to the salesman 110 and second consumer, if any, in the form of a credit to the cumulative credit information associated with the salesman record 202 of salesman 110 and consumer record 204 of the second consumer. After the cumulative credit of a salesman or consumer increases past a predefined threshold, the salesman or consumer is allowed to redeem the credit in the form a gift card of this choosing. The salesman or consumer may effectuate the redemption by logging onto the server 102 online and making his selection.

In one embodiment of the present invention, the administrator 130 may generate offers, promotions, discounts and sales that are stored by the server 102. The offers, promotions, etc. may include a description of goods being promoted, a percentage discount on goods, a price for goods, a rebate on goods, still images, video, audio, a time limit for the promotion or sale, or the like. The data uploaded by the administrator may also include data pertaining to the target for the offer, such as a location, a region, a time period, demographic data describing individuals to which the offer is directed and/or specific names or address of the individuals to which the offer is directed. The administrator 130 may also set the commission rates for the salesmen and consumers.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. The computer readable medium does not include computer readable information in a transitory state medium.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for facilitating sales over a communications network, comprising:
providing a graphical user interface to an online marketplace of goods;
receiving, via the graphical user interface, a selection of goods and a salesman identifier from a consumer;
receiving, via the graphical user interface, sales transaction data comprising purchase of the selection of goods by the consumer;
processing the sales transaction data to effectuate purchase of the selection of goods by the consumer;
matching the salesman identifier to a stored record that corresponds to the salesman; and
transferring a credit to the salesman based on the sales transaction data.

2. The method of claim 1, wherein sales transaction data includes at least one or more product identifiers, consumer contact information and electronic payment information.

3. The method of claim 2, wherein processing the sales transaction data further comprises sending the sales transaction data to a payment gateway and receiving confirmation of payment from the payment gateway.

4. The method of claim 3, wherein matching the salesman identifier further comprises searching a database of records, wherein each record corresponds to a salesman, and comparing the salesman identifier to data in the records.

5. The method of claim 4, wherein transferring a credit to the salesman further comprises calculating a commission based on the sales transaction data and transferring a credit to the salesman equal to an amount of the commission.

6. The method of claim 5, wherein transferring a credit to the salesman further comprises adding the credit transferred to the salesman to a cumulative credit amount associated with a record in the database corresponding to the salesman.

7. The method of claim 6, further comprising:
providing a gift card to the salesman when the cumulative credit amount associated with the record corresponding to the salesman increases past a predefined threshold.

8. A method on a server for facilitating sales over a communications network, comprising:
providing a graphical user interface to an online marketplace of goods;
receiving, via the graphical user interface, a selection of goods and a referral identifier from a first consumer;
receiving, via the graphical user interface, sales transaction data comprising purchase of the selection of goods by the first consumer;
processing the sales transaction data to effectuate purchase of the selection of goods by the first consumer;
matching the referral identifier to a stored record that corresponds to the salesman and a stored record that corresponds to a second consumer; and
transferring a credit to the salesman based on the sales transaction data and transferring a credit to the second consumer based on the sales transaction data.

9. The method of claim 8, wherein sales transaction data includes at least one or more product identifiers, first consumer contact information and electronic payment information.

10. The method of claim 9, wherein processing the sales transaction data further comprises sending the sales transaction data to a payment gateway and receiving confirmation of payment from the payment gateway.

11. The method of claim 10, wherein matching the referral identifier further comprises searching a database of records, wherein each record corresponds to a salesman or a consumer, and comparing the referral identifier to data in the records.

12. The method of claim 11, wherein transferring a credit to the salesman further comprises calculating a commission based on the sales transaction data and transferring a credit to the salesman equal to an amount of the commission.

13. The method of claim 12, wherein transferring a credit to the salesman further comprises adding the credit transferred to the salesman to a cumulative credit amount associated with a record in the database corresponding to the salesman.

14. The method of claim 13, further comprising:
providing a gift card to the salesman when the cumulative credit amount associated with the record corresponding to the salesman increases past a predefined threshold.

15. The method of claim 11, wherein transferring a credit to the second consumer further comprises calculating a commission based on the sales transaction data and transferring a credit to the second consumer equal to an amount of the commission.

16. The method of claim 15, wherein transferring a credit to the second consumer further comprises adding the credit transferred to the second consumer to a cumulative credit amount associated with a record in the database corresponding to the second consumer.

17. The method of claim 16, further comprising:
providing a gift card to the second consumer when the cumulative credit amount associated with the record corresponding to the second consumer increases past a predefined threshold.

18. A system for facilitating sales over a communications network, comprising:
a database for storing records corresponding to salesmen and consumers; and a central server configured for:
providing a graphical user interface to an online marketplace of goods;
receiving, via the graphical user interface, a selection of goods and a salesman identifier from a consumer;
receiving, via the graphical user interface, sales transaction data comprising purchase of the selection of goods by the consumer;
processing the sales transaction data to effectuate purchase of the selection of goods by the consumer;
matching the salesman identifier to a record in the database that corresponds to the salesman; and
transferring a credit to the salesman based on the sales transaction data.

19. The system of claim 18, wherein sales transaction data includes at least one or more product identifiers, consumer contact information and electronic payment information.
